(19) United States
(12) Patent Application Publication
(10) Pub. No.: US 2014/0313986 A1
(43) Pub. Date: Oct. 23, 2014

(54) DEVELOPING TRANSMISSION GAPS FOR CALIBRATION PROCESSING

(71) Applicant: Magnolia Broadband Inc., Englewood, NJ (US)

(72) Inventors: Stuart S. JEFFERY, Los Altos, CA (US); Kenneth Kludt, San Jose, CA (US); Haim Harel, New York, NY (US)

(73) Assignee: Magnolia Broadband Inc., Englewood, NJ (US)

(21) Appl. No.: 14/042,020

(22) Filed: Sep. 30, 2013

Related U.S. Application Data
(60) Provisional application No. 61/813,787, filed on Apr. 19, 2013.

(51) Int. Cl. H04W 74/08

(52) U.S. Cl. CPC H04W 74/0816
USPC 370/329

(57) ABSTRACT

A plurality of co-located beamforming transceivers may transmit data to at least one user equipment according to a collision sense multiple access/collision avoidance (CSMA/CA) protocol. The plurality may include a first and a second beamforming transceiver. The first beamforming transceiver may request a calibration signal from the second beamforming transceiver. A processor or transceiver may identify a transmission gap between the user equipment and the plurality of beamforming transceivers. The second beamforming transceiver may transmit a calibration signal during the transmission gap to the first beamforming transceiver.

### CROSS REFERENCE TO RELATED APPLICATIONS

This application claims benefit of U.S. Provisional Patent Application No. 61/813,787 filed on Apr. 19, 2013, which is incorporated herein by reference in its entirety.

### FIELD OF THE PRESENT INVENTION

The present invention relates generally to the field of radio frequency (RF) 802.11x WiFi systems and methods for enhanced performance using RF beamforming and/or digital signal processing.

### BACKGROUND

Active antenna systems may implement 1-dimensional and 2-dimensional multi-beam base stations that focus transmission and reception into narrow sub-sectors, facilitate reduced interference to neighboring cells, and enable reuse of the radio spectrum at its own cell by activating independent simultaneous co-channel non-overlapping beams.

Base stations may separate transmission and reception by using different frequencies or different time divisions for transmission and reception. For example, cellular protocols, such as GSM (Global System for Mobile Communications), WiMAX (Worldwide Interoperability for Microwave Access), and LTE (Long-Term Evolution), may sync (synchronize) all transmission and receiving channels using time-division. Wi-Fi base stations, which may incorporate a multi-beamforming cluster of co-located, co-channel Wi-Fi access points, may not inherently include such syncing capabilities and may operate inefficiently when in close proximity, due to the nature of the CSMA/CA (Carrier sense multiple access with collision avoidance) property of the Wi-Fi protocol. The CSMA/CA property may require yielding to all first-come Wi-Fi data transmission in order to avoid transmission collisions or jamming. Further, while co-located, co-channel Wi-Fi access points may provide super-isolation of data transmission via RF manipulation methods, additional isolation between access points may be created through signal calibration. Performance may be improved if calibration can occur without significantly impacting network bandwidth.

### SUMMARY

A plurality of co-located beamforming transceivers may transmit data to at least one user equipment according to a CSMA/CA protocol. The plurality may include a first and a second beamforming transceiver. The first beamforming transceiver may request a calibration signal from the second beamforming transceiver. A processor or transceiver may identify a transmission gap between the user equipment and the plurality of beamforming transceivers. The second beamforming transceiver may transmit a calibration signal during the transmission gap to the first beamforming transceiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a multibeam access point, according to embodiments of the invention.

FIG. 2 is a timeline for receiving a calibration signal during a transmission gap, according to embodiments of the invention.

FIG. 3 is a logic flow diagram of a calibration method, according to embodiments of the invention.

FIG. 4 is a timeline for receiving a calibration signal during a transmission gap, according to embodiments of the invention.

FIG. 5 is a logic flow diagram of a calibration method using a beacon preamble, according to embodiments of the invention.

FIG. 6 is a flowchart of a method, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may be described in reference to the IEEE (Institute of Electrical and Electronics Engineer) 802.11 standard for implementing wireless local area networks (WLAN). “802.11xx” may refer to any version of the 802.11 standard, such as 802.11a, 802.11g, or 802.11ac, for example. Versions of the 802.11 standard may operate using a technique called Collision Sense Multiple Access/Collision Avoidance (CSMA/CA), a networking method which aims to prevent transmission collisions before they occur. While embodiments of the invention are described in terms of the 802.11 protocol, other network protocols built on the CSMA/CA concept may be used.

Access points (AP's) using a CSMA/CA wireless network, including IEEE 802.11 WiFi networks, may determine whether a radio channel is clear, prior to broadcasting or transmitting data in the channel. The AP may do this by performing a clear channel assessment (CCA), which includes two functions: listening to received energy on an RF interface (termed “energy detection”), or detecting and decoding an incoming Wi-Fi signal preamble from a nearby AP. A signal preamble may be a signal used to synchronize transmission timing between two devices and may occur at the beginning of every data packet. In a communication standard such as Wi-Fi, a preamble may have a predefined structure and data fields organized in a way that all devices communicating on the standard understand. A CCA is deemed ‘busy’ and thus not available if an AP's receiver can sense radio energy, from another AP, above a CCA sensitivity level or if an AP detects an incoming WiFi signal preamble. The AP may also maintain or store a Network Allocation Vector (NAV), which acts as a countdown timer to when the AP may begin to transmit data. Based on signals from nearby AP's which may indicate the length of a transmitted data packet, an AP's NAV may update the time to transmission, causing further delay to an AP's data transmission. An AP may defer from using the channel to transmit data until both conditions (e.g., CCA deemed ‘busy’ and the NAV timer) have expired.

According to embodiments of the invention, a Multibeam Access Point, which may act as a Wi-Fi base station, may include a cluster or plurality of co-located Wi-Fi access points or transceivers, each access point with independent transmit and receive capabilities. As used herein, transceiver and AP may be used interchangeably as any device having independent transmit and receive functions and capable of acting as a 802.11xx access point. Each access point or transceiver may use directive antennas to focus the radio energy on an azimuth covering an intended user on a user equipment (UE), enabling one or the same radio frequency or frequency channel (e.g., the same or overlapping frequency spectrum) to be used simultaneously or concurrently on a different azimuth beam which points to a different UE. Transceivers or access points may be co-located if, under ordinary usage of the CSMA/CA technique, data transmission from one transceiver prevents simultaneous data transmission from another transceiver on the same channel or frequency. The transceivers' co-location or proximity to each other may cause, for example, RF interference, a busy CCA, or an updated NAV. Co-located transceivers may be clustered or grouped together into one base station that serves UE's in a limited geographical area. Co-located transceivers may share processing tasks or may each have separate processing capabilities. Each access point or transceiver may be coupled to an individual antenna to broadcast or transmit data to a user equipment (UE). The antennas may be arranged in an antenna array. A beamforming antenna may be a directive antenna to focus radio energy on a narrow azimuth covering an intended user on a UE. Broadcasting on a narrow azimuth may enable one or the same frequency channel (e.g., the same or overlapping frequency spectrum) to be used simultaneously or concurrently on a different azimuth beam which points to a different UE.

In order for a multibeam access point to maintain a high capacity and serve multiple UE's simultaneously on the same channel, each transceiver's signal to a UE may require sufficient isolation to prevent interference with signals from other co-located transceivers. For example, one transceiver's data transmission to a UE may leak to or be received by another co-located transceiver, interfering with the co-located transceiver's data transmission with another UE. One remedy is to create RF and antenna isolation between each transceiver. Isolation may be accomplished by applying different techniques such as physical separation of transceiver antennas and manipulating antenna patterns, but leakage may still occur though scattering, multipath, back lobe leakage or a multitude of other paths. Despite design approaches to minimize this leakage, some residual leakage of the second transceiver into the first transceiver will occur. Another remedy may be to nullify or cancel residual leakage signals by analog or digital processing through phase shifting and attenuation adjustments.

This residual leakage may be removed by subtracting a replica of a second transceiver signal from the composite signal (signal of interest plus leakage from second transceiver) received by a first transceiver. The replica of the second transceiver may require the same characteristics as the leakage component of the second transceiver. The characteristics (phase and amplitude) of the leakage version of the signal transmitted by the second transceiver may be determined by calibration.

Calibration may be accomplished by identifying a time period when the radio environment is controlled so that the only signal present is a calibration signal. During this interval (the calibration interval) the characteristic of the leakage signal (phase and amplitude) may be measured. This same phase and amplitude value may then be applied to a replica of the transmitted signal.

A key requirement of calibration may be determining a time when only the calibration signal is present. This may be accomplished by shutting down the operation of the system periodically and entering a calibration period. This is not an operational problem if calibration is need very infrequently (once a month or so). However, an accurate determination of the phase and amplitude adjustment may be required to remove the leakage component may require more frequent calibration, giving rise to the requirement for continuous, minimally disruptive calibration.

The phase shift or attenuation values may be determined by sending or transmitting calibration signals between co-located transceivers and calculating or determining appropriate phase shift and attenuation values that may properly null (e.g. void, cancel, or bring the signal to zero) the leaked signals from each transceiver. Calibration may involve injecting a known signal into the antennas, detecting the resulting output in a manner that measures the characteristics of the antenna, and adjusting the phase shifters and attenuators to achieve the desired results. In order to prevent external signals from interfering with the calibration process, the calibration signals may need to be transmitted during a transmission gap between the multibeam access point and the UE's it is serving. The transmission gap may be a specific time interval where data transmission between co-located transceivers and UE's is paused or ceased. Embodiments of the invention may allow transmission of calibration signals between co-located transceivers without decreasing the capacity or bandwidth of a multibeam access point.

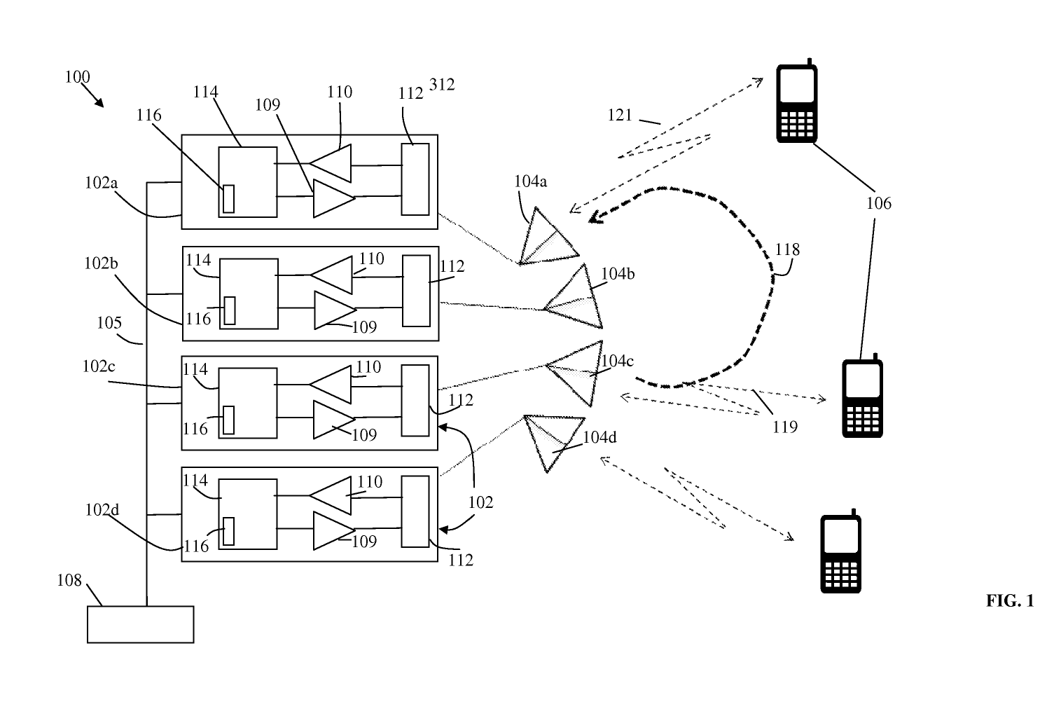

FIG. 1 is an illustration of a multibeam access point, according to embodiments of the invention. The multibeam access point or base station 100 may include, for example, four beamforming transceivers 102a-d or access points transmitting on the same channel or frequency channel. Other base stations may include more or fewer access points, but no less than two. Each transceiver or access point 102 may be coupled to an antenna 104 which may form directive beams 105 to transmit data to a UE 106. A UE 106 (or “UE 106”) may be a cell phone, smart phone, tablet or any device with Wi-Fi capability and able to communicate with a Wi-Fi access point, or another wireless capable device. UE's 106 may be recognized in a WLAN as a Station (STA) device, according to the IEEE 802.11xx protocol. Each transceiver 102a-d may operate according to the IEEE 802.11xx protocol, or other protocol using CSMA/CA. A controller 108 may interface with or control each transceiver 102a-d. The transceivers 102a-d may each include for example a transmitter 109, receiver 110, antenna interface or RF circuitry 112, and a processor 114 and memory 116, although other or different equipment may be used. Processors 114 and 108 may be a general purpose processor configured to perform embodiments of the invention by for example executing code or software stored in memory 116, or may be other processors, e.g. a dedicated processor.

Due to the proximity of the transceivers 102a-d and their antennas 104a-d, a small amount of a signal 119, transmitted by transceiver 104c, may “leak” as a leakage signal 118 into the receiver of transceiver 104a. Leakage signal 118 may be transmitted by one transceiver, such as transceiver 104c, as illustrated, and received by transceiver 104a. The leakage signal 118 may interfere with data transmission between transceiver 104a and its UE 106. Each transceiver may be inadvertently transmitting this leakage signal to each of the other transceivers. In order to null leakage signal 118 and prevent leakage signal 118 from disturbing or interfering with data transmission between transceiver 104a and UE 106, a replica of signal 119 may be subtracted from the total signal received by transceiver 104a. This total signal received by transceiver 104a may, for example, be a signal from UE 106 (e.g., signal 121) and the leakage signal 118. When leakage signal 118 is subtracted from the total signal received by transceiver 104a, signal 121 remains.

A well-known subtraction technique may be used to null the leakage signal 118. For subtraction to be useful, phase and amplitude of the leakage signal 118 may be measured during a calibration interval. Calibration may be performed when the only signal detected by transceiver 104a is the leakage signal 118. All other transceivers may be required not to operate during calibration so that the measurement being made by receiver 116 is only the leakage signal.

The actual calibration signal needs to have characteristics similar the actual signal that is being subtracted. It can be a special short duration signal (as required if the calibration interval is a very short SIFS interval) or it could be an actual WiFi signal (as when calibration is done using the WiFi beacon).

For example, transceiver 104a may request a calibration signal from transceiver 104c. A calibration signal may be a signal with properties (e.g., frequency, phase, amplitude or other similar properties) known or previously agreed upon by each co-located transceivers 104a-d. This may be so that each transceiver 104a-d is able to detect abnormalities or irregularities in received calibration signals and account for these irregularities during calibration. Requests for calibration may occur, for example, through a wire connection 105 between each of the co-located transceivers 104a-d. Processor 114 or controller 108 may identify or define a transmission gap between the multibeam access point 100 (including its transceivers 104a-d) and its serving UE's. The transmission gap may be a time interval scheduled or determined by one of the transceivers (e.g., transceiver 104a) or processors 114, where no data transmission occurs between the transceivers 104a-d and any of the UE's 106. The transmission gap may further be defined to occur during standard data transfers required by a CSMA/CA protocol. Processor 108 or 114 or transceiver 104a may, for example, transmit a timestamp or notification to the other transceivers indicating when the transmission gap may occur. A timestamp may, for example, be a series of characters or bits that describe a particular future time. During the transmission gap, transceiver 104c may transmit a calibration signal to transceiver 104a or to the other transceivers 104b and 104d. The transmission gap may be, for example, a short interframe space (SIFS) or may occur during a beacon preamble. Other transmission gaps may be determined or scheduled.

The calibration sequence may be accomplished by each transceiver 104a-d, one at a time, transmitting a calibration signal while one or all the other transceivers measure the phase and amplitude of the signal. The final values of phase and amplitude may require integration over many measurements to obtain an accurate value. For the SIFS approach, where the individual measurement is less than 10 μsec, thousands of samples may be required. For the beacon approach, where individual measurement is several hundred μsecs, the number of samples may be reduced.

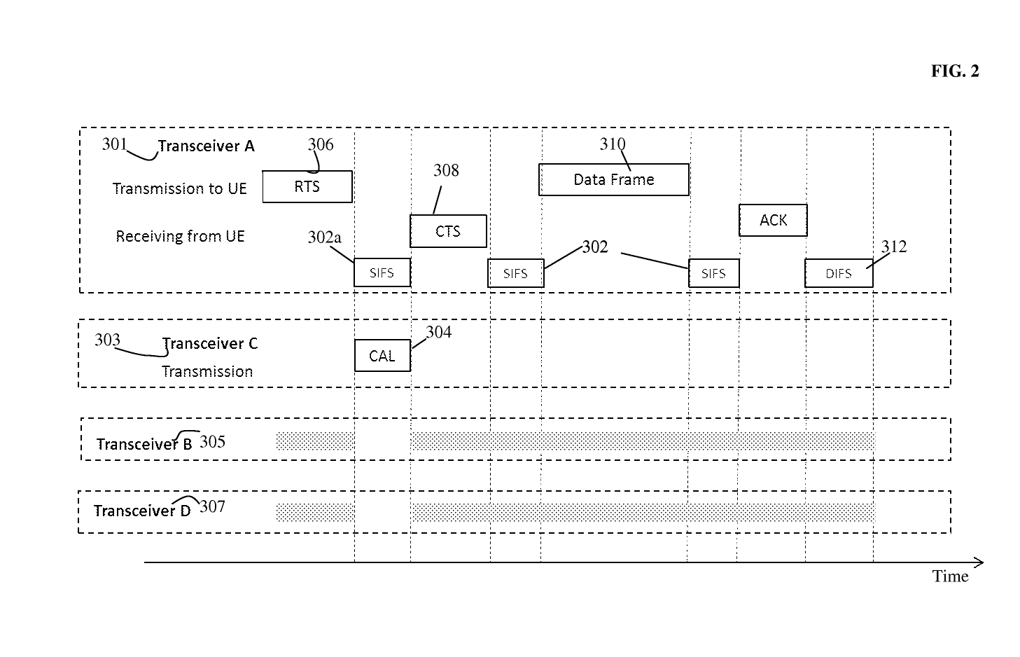

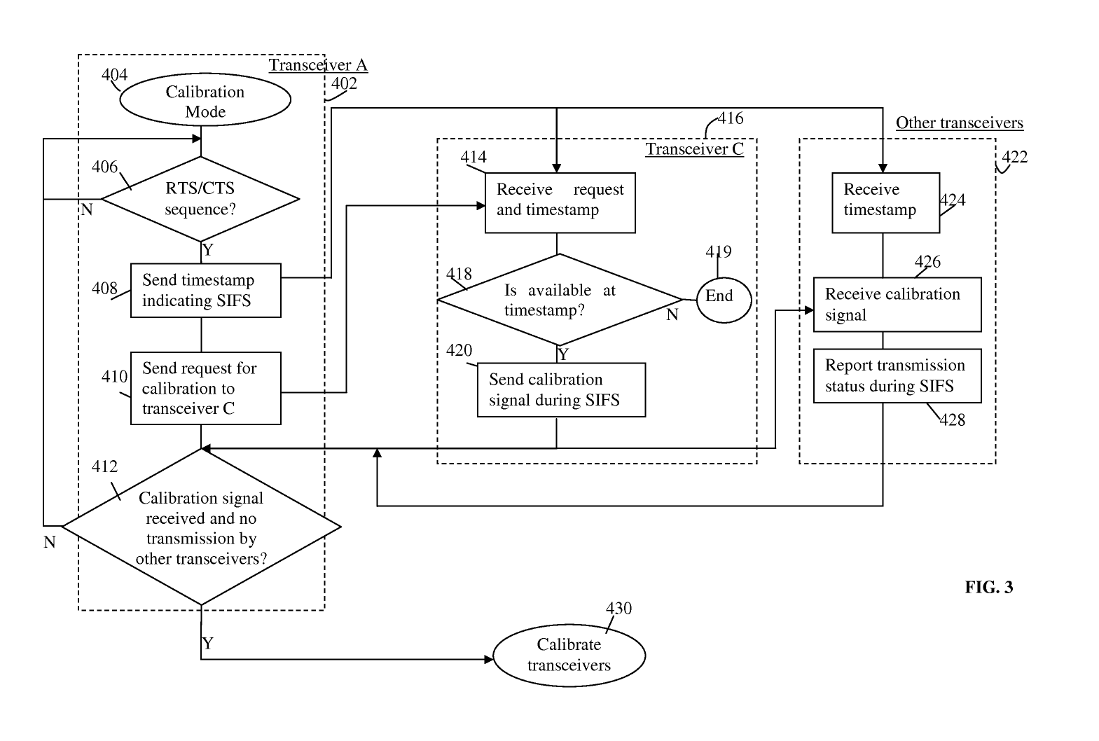

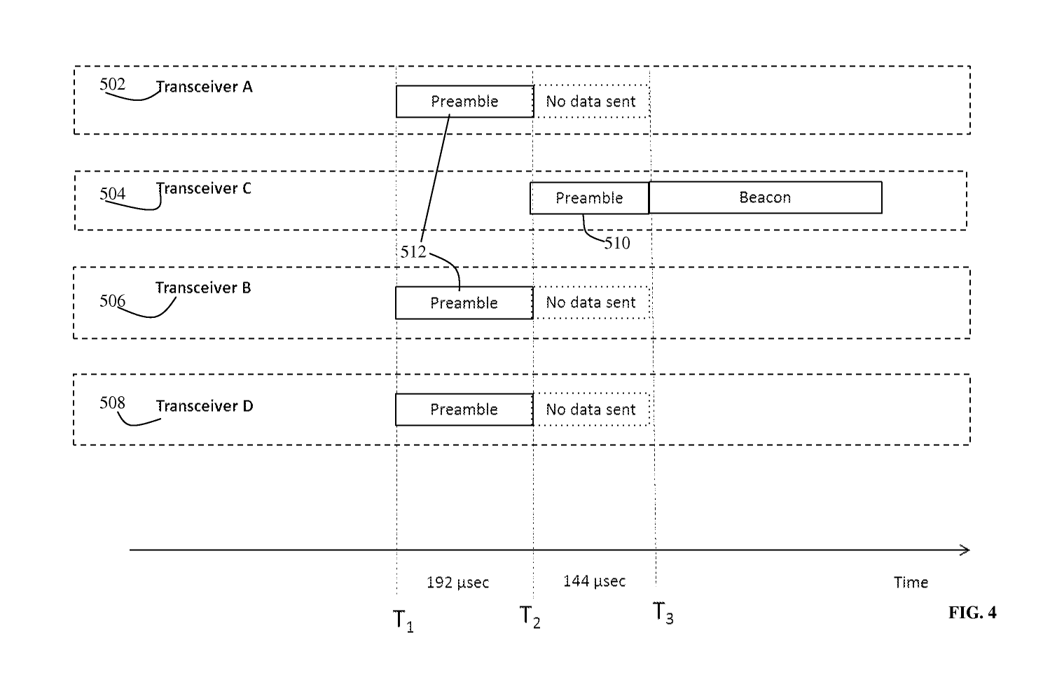

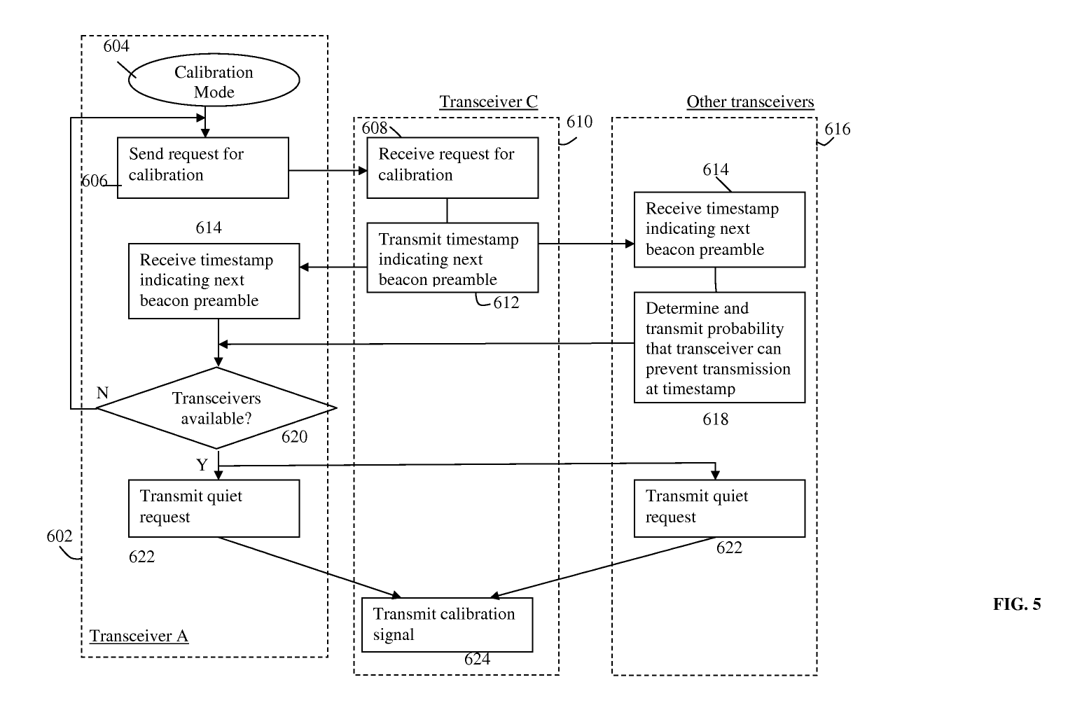

The exact time required is a field tuned adjustment based on the specifics of the installation. However, calibration is a continuing running process, where new calibration data is applied to long term averaged data, slowly adjusting the value. In the following sections, two approaches are described: (a) using SIFS described in FIGS. 2 and 3 (b) using a beacon preamble described in FIGS. 4 and 5. The SIFS approach may not result in any loss of system service to UE; the preamble beacon approach may result in some minor loss of systems service to UE.

FIG. 2 is a timeline for receiving a calibration signal during a transmission gap, according to embodiments of the invention. A processor or a transceiver A 301 may identify a transmission gap by identifying or determining when a SIFS 302 is to occur, e.g., determining the time period. SIFS 302 may occur during a Request To Send/Clear to Send (RTS/CTS) sequence with a UE (e.g., 106 in FIG. 1). The RTS/CTS sequence may be an “atomic” sequence, meaning that every step of data transmission must occur for the sequence to be successful. The RTS/CTS sequence may be useful in a CSMA/CA protocol, such as 802.11xx, to reduce data frame collisions between transceivers and UE's, and may be used for data transfers that require acknowledgment. According to the 802.11 protocol, a RTS/CTS sequence may include an RTS packet 306 sent by transceiver A 301, a CTS packet 308 received from a UE, and a data frame packet 310 sent by transceiver A 301, with a Short Interframe Space (SIFS) of about 10 microseconds between each packet. Transceiver A 301 may request calibration from transceiver C 303, for example. Transceiver A may initiate or activate a RTS/CTS sequence with a UE and identifying the occurrence of a SIFS. Transceiver A may identify, define, or schedule a transmission gap between the transceivers and UE's by sending or transmitting a timestamp to each of the other transceivers (e.g., transceiver C 303, transceiver B 305, and transceiver D 307, as shown) indicating the time when an RTS frame may be completed, or when a SIFS may start. Transceiver C 303 may transmit a calibration signal 304 during the identified transmission gap, e.g., the first SIFS 302a as shown. During the SIFS 302a, transceiver B 305 and transceiver D 307 may cease transmission or prevent transmission from a UE so that a transmission gap is maintained between the transceivers and all UE. In the time intervals where transceiver C 303 is not transmitting a calibration signal, transceiver B 305 and transceiver D 307 may carry on normal data transmission functions.

As shown in FIG. 2, the RTS/CTS sequence may include three SIFS 302 (each 10 μsec long) and 1 DIFS 312 (Distributed Coordination Function Interframe Space, 28 μsec long) and each one may be used as an identified transmission gap for transmitting a calibration signal 304. However, due to propagation delays which may occur as the RTS/CTS sequence progresses, the first SIFS 302a may occur at the most accurate or precise time. Thus, it may be advantageous to identify the transmission gap as the first SIFS 302a so that the full 10 μsec may be used to receive a calibration signal.

FIG. 3 is a logic flow diagram of a calibration method, according to embodiments of the invention. A transceiver A 402 may be in a calibration mode 404 and may identify or schedule a transmission gap between co-located transceivers and all UE. Transceiver A 402 may wait until an RTS/CTS sequence 406 is initiated or activated. If transceiver A 402 initiates a RTS/CTS sequence 406, transceiver A 402 may transmit or send a time stamp indicating the start of a SIFS 408. The timestamp may be sent or transmitted to all the other transceivers 422 co-located with transceiver A 402. Transceiver A may also send a request to a particular co-located transceiver, such as transceiver C 416, from which to receive a calibration signal. Transceiver C 416 may receive the request and the timestamp 414 from transceiver A 402, and transceiver C 416 may determine 418 whether it is available to send a calibration signal at the timestamp. If transceiver C 416 is not available due to being occupied with other functions, then transceiver C 416 does not send a calibration signal 419. If transceiver C 416 is available, then transceiver C 416 may transmit or send a calibration signal during the identified transmission gap, the SIFS, at the specified timestamp. The other co-located transceivers 422, may receive the timestamp 424 from transceiver A 402 and may receive the calibration signal 426 from transceiver C 416 during the transmission gap indicated by the received timestamp. If the other co-located transceivers 422 are not occupied with other functions, the co-located transceivers 422 may not transmit during the transmission gap, e.g., the SIFS. It may be possible, though, that the other co-located transceivers 422 are occupied with data transmission with other UE. In any case, the other transceivers 422 may report their transmission status 428 to a central processor or transceiver A 402.

After the SIFS or transmission gap has passed, transceiver A 402 may determine whether a calibration signal was received from transceiver C 416 and whether the other co-located transceivers 422 reported no transmission during the SIFS. If these conditions are met, a successful transmission of calibration data or signal has occurred for at least transceiver A 402, and transceiver A 402 may calibrate accordingly. The other co-located transceivers 422 may be calibrated with the received calibration signal from transceiver C 416 if the other co-located transceivers 422 did not receive any data from a UE. If any of the other co-located transceivers 422 were receiving data from a UE during the SIFS, then the received signal from the UE would interfere with the received calibration signal, and the co-located transceivers 422 may not be able to calibrate. If the conditions of operation 412 are not met, transceiver A 402 may continue to wait until another RTS/CTS sequence is initiated with a UE. Transceiver A may continue calibration mode 404 until it has received a sufficient amount or number of successful calibration events. Transceiver A may request a calibration signal from the other co-located transceivers 422, not just transceiver C 416. When transceiver A is finished calibrating, the other co-located transceivers 422 may have also collected or received a substantial amount of successful calibration events, however, the other co-located transceivers 422 may have received fewer successful calibration events due to interference from UE's transmitting to the co-located transceivers 422. If the other co-located transceivers need additional calibration signals, the other co-located transceivers 422 may start the same calibration mode as transceiver A 402.

The SIFS calibration procedure may be executed without any reduction of data flow in the network because it may take advantage of naturally occurring SIFS's. The RTS/CTS sequence may be a normal part of data transfer between transceivers and UE's and may occur at for example about 100 times per second; other rates may be used.

The technique described in FIG. 3 may assure that transceiver A is silent during the interval. If the other co-located transceivers are silent, then the calibration signal from transceiver C may be used by transceiver A. However it may be possible that UE's are transmitting to the other co-located transceivers. In general, the other co-located transceivers can assure a quiet calibration interval if they generate their own SIFS request. If, for example, a multibeam access point includes 4 transceivers, the following timing estimates may indicate the time for a full calibration of a multibeam access point:
A full calibration may require 0.1 seconds of calibration data or signal;
SIFS window=10 μsec;
RTS/CTS rate=100 per second;
Since 802.11 may operate on three channels, the probability that other three channels are not transmitting=0.125 (three channels, each 0.5 active=0.5̂3);
Real time to calibrate:
At 10 μsec per SIFS interval, 10,000 successful intervals may be required for 0.1 second of calibration data;
At 0.125 probability of success, 80,000 attempts may be needed to obtain 10,000 success (10,000/0.125);
At 100 attempts per second, 800 seconds (or 13.3 mins) may be required for one transceiver (80,000/100) to calibrate;
With 4 transceivers and 3 calibration paths (for each channel), there may be 12 calibration sets, so approximately 2.7 hours per day may be required for full calibration.

Based on the above estimation, calibrating multiple times per day may be accomplished. Since SIFS calibration may have no impact on channel utilization a multibeam access point may be calibrated continuously as a background function. At approximately 2.7 hours per cycle, about 9 cycles can be accomplished every 24 hours. This may be increased if less than 0.1 seconds of calibration signal or data is required. Other parameters and numbers of equipment may be used.

FIG. 4 is a timeline for receiving a calibration signal during a transmission gap, according to embodiments of the invention. A calibration signal may be sent, for example, as a preamble to a standard 802.11 beacon. According to the 802.11 standard, beacons may be ordinarily transmitted to announce presence of a network to other nearby networks. To use a beacon's preamble 510 as a calibration signal, a transmission gap may be created so that the co-located transceivers not transmitting the calibration signal stay quiet during the transmission gap interval. For example, a transceiver A 502 may request a calibration signal from a transceiver C 504. If transceiver C 504 is available to send a calibration signal (e.g., a beacon preamble 510), each of the other transceivers, e.g., transceiver A 502, transceiver B 506, and transceiver D 508, may transmit a quiet request 512 in the form of a preamble in a standard 802.11 format, for example, so that a channel is reserved by each of the other transceivers. The quiet request 512 may indicate that the channel is to be reserved for the length or duration of a beacon preamble 510, which may act as the calibration signal. For the 802.11 standard, the beacon preamble 510 may be 144 μsec. Since a standard preamble may be 192 μsec, the other co-located transceivers may transmit a preamble 512 at T1, 192 μsec prior to the beacon preamble 510. Since the transceivers 502 506 and 508 may be operating according to a CSMA/CA protocol, the quit request 512 may inform UE's performing a CCA check that those channels are occupied, and thus, the UE's may hold transmission during the beacon preamble's 510 time interval.

FIG. 5 is a logic flow diagram of a calibration method using a beacon preamble, according to embodiments of the invention. A transceiver A 602 may be in calibration mode 604 and may identify or schedule a transmission gap between co-located transceivers and all UE being served by the co-located transceivers. Transceiver A 602 may send or transmit a request for calibration from another co-located transceiver, such as transceiver C 610. Transceiver C 610 may receive the request for calibration 608 and transmit a timestamp indicating when the next beacon preamble is to occur. Transceiver A 602 and the other co-located transceivers may receive the timestamp 614 from transceiver C 610. The other transceivers 616 may determine, based on a predicted amount of traffic for example, the probability that each transceiver is able to send a quiet request and prevent data transmission at the timestamp received from transceiver C 610. At operation 620, transceiver A 602 or a processor may determine whether the transceivers are available for a calibration signal to be transmitted by transceiver C 610. Transceiver A 602 or a processor may, for example, calculate the probability that all co-located transceivers will remain silent by multiplying all of the probabilities received from the other co-located transceivers at operation 618. If the probability is greater than a threshold, e.g., greater than 90%, all co-located transceivers may be deemed available for the calibration. Transceiver A and the other co-located transceivers 616 besides transceiver C may transmit a quiet request 622 at a time interval prior to the scheduled or identified transmission gap (e.g., the timestamp of the beacon preamble identified by transceiver C 610). For example, the quiet request may be a standard 802.11 preamble, which may be 192 μsec. Transceiver A and the other co-located transceivers 616 may transmit a standard preamble 192 μsec prior to the schedule beacon preamble, in order to reserve their channels. UE's may receive the standard preambles from transceiver A and the other co-located transceivers, and their CCA check may allow them to withhold transmission during the beacon preamble's time interval. After the quiet request, transceiver C 610 may transmit the requested calibration signal 624 during the identified transmission gap. During the transmission gap, neither transceiver A 602 nor the other co-located transceivers 616 may transmit or receive data from UE's. If the calibration signal is transmitted without concurrent data transmission from transceiver A 602 or the other co-located transceivers 616, transceiver A 602 and the other co-located transceivers 616 may use the received calibration signal for calibration.

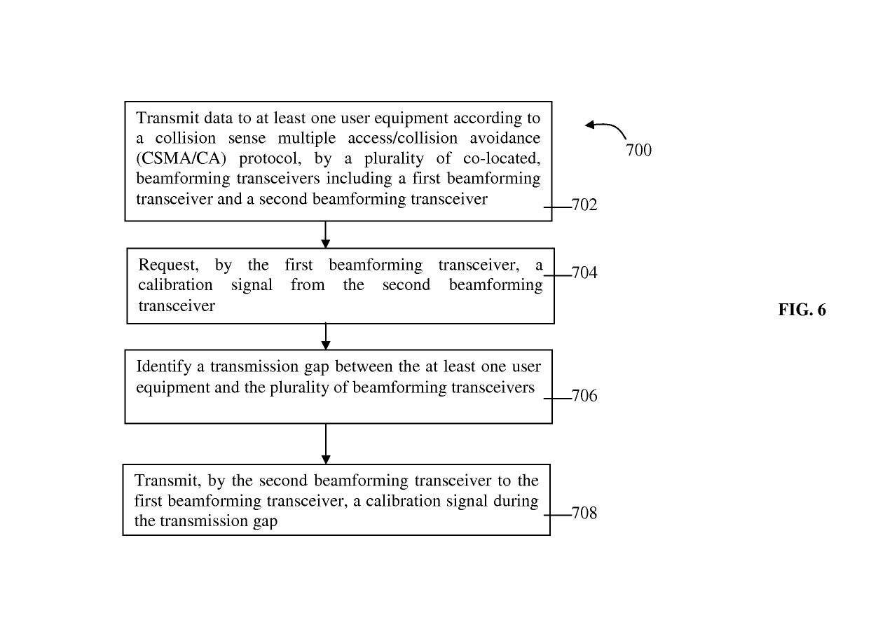

The calibration procedure described in FIG. 6 may have a slight impact on the capacity of the multibeam access point network. Every time a quiet request packet is sent, time may be consumed that could be used for data traffic. The following timing estimations illustrate the time it takes to calibrate a multibeam access point using the above described calibration procedure:
Full calibration may require 0.1 seconds of calibration data;
Quiet Request window=144 μsec;
Beacon rate=10 per second;
Estimate that each of three transceivers (e.g., transceivers A, B and D) will be able to send quiet request, assuming loading of collision probability=0.036, assuming 33% transmission on each channel;
Real time to calibrate:
At 144 μsec per beacon preamble interval, 695 intervals may be required for 0.1 second of calibration data;
At 10 Beacons per second, 70 secs required for 695 intervals;
At 3.6% blockage rate, 1944 seconds adjusting that upward by 5%, to allow for errors in predicting ability to generate QR pulse, the time becomes 2042 seconds, or about 34 minutes for 1 beam or about 2.3 hrs for 4 beams
Percentage of capacity consumed by quiet requests may be about 0.3%, computed as follows:
Number of QR pulses sent per second 10
Preamble plus QR pulse is 336 μsec
Percentage consumed=(10*336 μsec)=0.003 sec=0.3%
Other or different parameters may be used.

FIG. 6 is a flowchart of a method, according to embodiments of the invention. In operation 702, a multibeam access point including a plurality of transceivers may transmit data to at least one user equipment according to a collision sense multiple access/collision avoidance (CSMA/CA) protocol, such as IEEE 802.11 for example. The multibeam access point may include at least a first beamforming transceiver and a second beamforming transceiver. Other beamforming transceivers may also be part of, or co-located with, the first and second beamforming transceiver. In operation 704, the first beamforming transceiver may request a calibration signal from the second beamforming transceiver. In operation 706, a processor or the first transceiver may identify, define, or schedule a transmission gap between the at user equipment and the multibeam access point including the plurality of beamforming transceivers. The second transceiver and the other transceivers may indicate to the first transceiver whether they are available during the identified transmission gap. The other co-located transceivers besides the first and second beamforming transceivers may prevent or cease transmission to UE during the transmission gap. In operation 708, the second beamforming transceiver may transmit a calibration signal to the first beamforming transceiver during the transmission gap.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

In various embodiments, computational modules may be implemented by e.g., processors (e.g., a general purpose computer processor or central processing unit executing software), or digital signal processors (DSPs), or other circuitry. The baseband modem may be implanted, for example, as a DSP. A beamforming matrix can be calculated and implemented for example by software running on general purpose processor. Beamformers, gain controllers, switches, combiners, and phase shifters may be implemented, for example using RF circuitries.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

1. A method of wireless communication, comprising:
transmitting data to at least one user equipment according to a collision sense multiple access/collision avoidance (CSMA/CA) protocol, by a plurality of co-located, beamforming transceivers including a first beamforming transceiver and a second beamforming transceiver;
requesting, by the first beamforming transceiver, a calibration signal from the second beamforming transceiver;
identifying a transmission gap between the at least one user equipment and the plurality of beamforming transceivers; and
transmitting, by the second beamforming transceiver to the first beamforming transceiver, a calibration signal during the transmission gap.

2. The method of claim 1, comprising transmitting, by the second beamforming transceiver, the calibration signal to each of the plurality of beamforming transceivers, during the transmission gap.

3. The method of claim 1, wherein identifying the transmission gap comprises identifying a Short Interframe Space (SIFS).

4. The method of claim 1, comprising initiating, by the first beamforming transceiver, a request to send/clear to send (RTS/CTS) sequence with a user equipment.

5. The method of claim 4, comprising transmitting, by the first beamforming transceiver, a timestamp indicating a start time of a SIFS to each of the plurality of beamforming transceivers.

6. The method of claim 1, wherein identifying the transmission gap comprises determining when the second beamforming transceiver is to transmit a beacon preamble.

7. The method of claim 6, wherein the beacon preamble is the calibration signal.

8. The method of claim 6, comprising generating, by each of the plurality of beamforming transceivers other than the second transceiver, a quiet request message prior to transmission of the beacon preamble thereby ceasing data transmission during the beacon preamble.

9. A wireless communication system, comprising:
a plurality of co-located, beamforming transceivers, each configured to transmit data to at least one user equipment according to a collision sense multiple access/collision avoidance (CSMA/CA) protocol, wherein the plurality of beamforming transceivers includes:
a first beamforming transceiver to request a calibration signal from a second beamforming transceiver;
a processor configured to identify a transmission gap between the at least one user equipment and the plurality of beamforming transceivers; and
a second beamforming transceiver to transmit, to the first beamforming transceiver, a calibration signal during the transmission gap.

10. The wireless communication system of claim 9, wherein the second beamforming transceiver is to transmit the calibration signal to each of the plurality of beamforming transceivers, during the transmission gap.

11. The wireless communication system of claim 9, wherein the processor is configured to identify the transmission gap by identifying a Short Interframe Space (SIFS).

12. The wireless communication system of claim 9, wherein the first beamforming transceiver is to initiate a request to send/clear to send (RTS/CTS) sequence with a user equipment.

13. The wireless communication system of claim 12, wherein the first beamforming transceiver is to transmit a timestamp to each of the plurality of beamforming transceivers indicating a start time of a SIFS.

14. The wireless communication system of claim 9, wherein the processor is configured to identify the transmission gap by determining when the second beamforming transceiver is to transmit a beacon preamble.

15. The wireless communication system of claim 14, wherein each of the other beamforming transceivers is to generate a quiet request message prior to the beacon preamble thereby ceasing data transmission during the beacon preamble

16. A multibeam access point device, comprising:
a plurality of beamforming access points, each configured to transmit data to at least one user equipment according to a collision sense multiple access/collision avoidance (CSMA/CA) protocol;
a controller to:
determine a time interval for when data is not transmitted to any user equipment by the plurality of beamforming access points; and
transmit a calibration signal from one of the beamforming access points to each of the other beamforming access points during the determined time interval.

17. The device of claim 16, wherein the controller is to determine the time interval based on an initiation of a request to send/clear to send (RTS/CTS) sequence by one of the beamforming access points.

18. The device of claim 17, wherein the controller is to determine the time interval based on when a Short Interframe Space (SIFS) occurs.

19. The device of claim 16, wherein the controller is to determine the time interval based on when a beacon preamble will be transmitted by one of the beamforming access points.

20. The device of claim 19, wherein each of the plurality of beamforming access points other than the beamforming access point transmitting the beacon preamble are to generate a quiet request message prior to the beacon preamble.

21. The method of claim 1, wherein said first and second beamforming transceivers are access points.

22. The method of claim 1, further comprising:
receiving the calibration signal at the first beamforming transceiver; and
measuring characteristics of said calibration signal by the first beamforming transceiver.

23. The method of claim 22, wherein the measured characteristics include at least phase and amplitude of said calibration signal.

24. The wireless communication system of claim 9, wherein said first and second beamforming transceivers are access points.

25. The wireless communication system of claim 9, wherein said first beamforming transceiver is further to receive and measure characteristics of the calibration signal.

26. The wireless communication system of claim 25, wherein the measured characteristics include at least phase and amplitude of said calibration signal.
